(19) United States
(12) Patent Application Publication
(10) Pub. No.: US 2002/0167941 A1
(43) Pub. Date: Nov. 14, 2002

(54) Method for data transmission via an IP-oriented network

(76) Inventors: Wolfgang Brueggemeier, Delbrueck (DE); Michael Karrengarn, Muenster (DE); Gisbert Kage, Paderborn (DE)

Correspondence Address: Bell, Boyd & Lloyd LLC, P.O. Box 1135, Chicago, IL, 60690, US

(21) Appl. No.: 10/119,629

(22) Filed: Apr. 9, 2002

(30) Foreign Application Priority Data
Apr. 9, 2001 (DE) 101 17 680.5

(51) Int. Cl. H04L 12/28

(52) U.S. Cl. 370/352; 370/351

(57) ABSTRACT

A method is provided for data transmission between a first device and a second device via an IP-oriented network, wherein a security device is disposed between the first and the second device. In particular, data transmission between CORBA objects beyond one or more security devices is implemented by the invention wherein, when a message packet transmitted by the first device is received at the security device, it is ascertained with reference to a subcomponent of the received message packet whether the first device or the CORBA object running on the first device is released for data transmission via the security device.

### BACKGROUND OF THE INVENTION

The present invention relates to a method for data transmission between a first device and a second device via an IP-oriented network (IP-N), wherein a security device is disposed between the first and the second device.

In modern software architectures, individual software components, also referred to as objects, are increasingly being run on different devices of a network. In this context, the literature frequently refers to distributed objects. Networks of this type often involve IP-oriented (Internet Protocol) networks; e.g., the Internet or local area networks (frequently abbreviated to LAN).

In the context of distributed objects, the relevant objects and the associated interfaces, also referred to as methods, are defined in such a way that the interface of an object can be selected by the other objects; i.e., that communication is enabled among the objects. The network device on which the individual objects run is irrelevant; i.e., communication between the individual objects is not restricted to a network device, but can take place among all devices.

A known technology for the implementation of distributed objects is referred to as the CORBA architecture (Common Object Request Broker Architecture). Communication between CORBA objects is known as end-to-end communication; i.e., a direct connection exists between the two CORBA objects. One CORBA object accesses a further CORBA object which is running on a different device via an “object reference,” often abbreviated in the literature to IOR. An object reference includes a network address which uniquely identifies the other device and further object-specific characteristics, via which the CORBA object is uniquely identified on the other device.

However, the use of end-to-end communication according to the CORBA architecture is restricted by the security problems in networks, such as the Internet. The use of security devices, often referred to as “firewalls,” imposes a subdivision of the end-to-end communication into multi-stage communication; i.e., communication between objects running on different devices with the intermediate connection of one or more firewalls.

Here, the problem occurs that, for communication between distributed objects beyond one or more firewalls, both the objects and the firewalls must be set up manually for this purpose. Different settings must be defined for different firewall products, so that a device of this type incurs a high administrative cost.

An object of the present invention is, therefore, to provide measures via which the relevant objects and firewalls can be set up automatically.

### SUMMARY OF THE INVENTION

According to the present invention, data transmission occurs between a first and a second device via an IP-oriented network, wherein a security device is disposed between the first and the second device. When a message packet transmitted by the first device is received at the security device, it is ascertained with reference to a subcomponent of the received message packet whether the first device is released for data transmission via the security device.

An essential advantage of the method according to the present invention is that the method can be implemented in a simple manner and at no great expense into existing systems.

A further advantage of the method according to the present invention is that the method is generally applicable and can, therefore, be used for different firewall products without modification.

An advantage of designs of certain embodiments of the present invention is, inter alia, that secure information transmission can be guaranteed through the use of standardized transmission protocols, such as the IIOP protocol (Internet Inter-ORB Protocol), for information transmission via the IP-oriented network.

Additional features and advantages of the present invention are described in, and will be apparent from, the following Detailed Description of the Invention and the Figures.

### BRIEF DESCRIPTION OF THE FIGURES

FIG. 1 shows a structural diagram schematically representing the essential functional units involved in the method according to the present invention.

FIG. 2 shows a flow chart illustrating the essential method steps which take place in the method according to the invention.

### DETAILED DESCRIPTION OF THE INVENTION

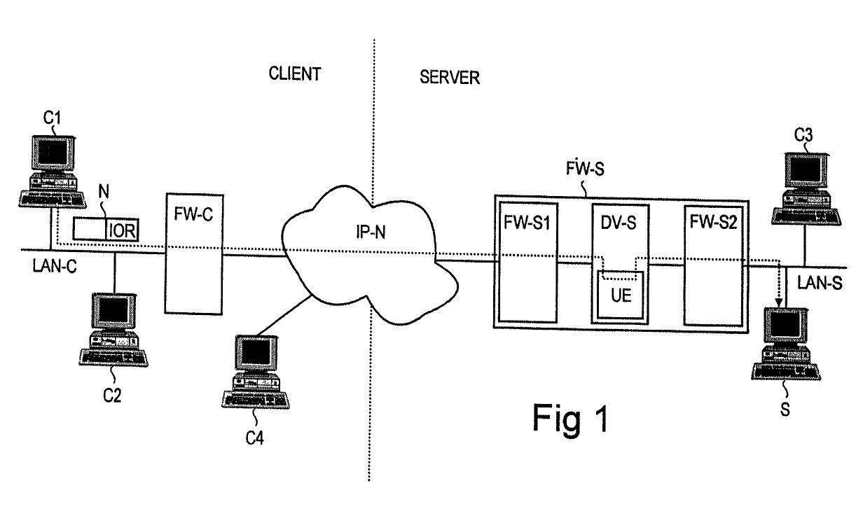

FIG. 1 shows a structural diagram schematically representing a “client-server” architecture. In particular, FIG. 1 shows a first local area network LAN-C (hereinafter referred to as the client network LAN-C) and a second local area network LAN-S (hereinafter referred to as the server network LAN-S) whereby the client network LAN-C and the server network LAN-S are interconnected via an IP-oriented network IP-N; for example, the Internet.

The client network LAN-C is connected via a client-side firewall FW-C and the server network LAN-S is connected via a server-side firewall FW-S to the IP-oriented network IP-N. Via the client-side firewall FW-C and the server-side firewall FW-S, a security disconnection of the local area networks LAN-C, LAN-S from the IP-oriented network IP-N is, in each case, effected; i.e., unauthorized two-way data transmission between the local area networks LAN-C, LAN-S and the IP-oriented network IP-N is prevented via the firewalls FW-C, FW-S. The server-side firewall FW-S includes a first firewall FW-S1, a second firewall FW-S2 and a data processing device DV-S disposed between the first and the second firewall FW-S1, FW-S2. An application UE, also frequently referred to as a “proxy,” via which an address conversion according to the present invention is implemented for data transmission via the server-side firewall FW-S, runs on the data processing device DV-S.

In the present embodiment, a first and a second client device C1, C2 are connected to the client network LAN-C. A server device S and a third client device C3 are connected to the server network LAN-S. In addition, a fourth client device C4 is directly connected to the IP-oriented network IP-N. The client and server devices C, S are, for example, designed as personal computers (PC) or workstations.

The method according to the present invention is explained below with reference to an example involving a transfer of a message packet N (illustrated by the broken arrow), originating from the first client device C1, to the server device S. CORBA applications (not shown), also frequently referred to in the literature as CORBA objects, via which the two-way transmission of message packets N is initialized and controlled, run on both the first client device C1 and the server device S. The message packets N are transferred via a TCP/IP connection (Transmission Control Protocol/Internet Protocol) which is set up between the first client device C1 and the server device S, wherein the TCP/IP connection is, in each case, interrupted by the client-side firewall FW-C and the server-side firewall FW-S.

One CORBA object accesses the CORBA object running on the respective other device via an “object reference”—frequently abbreviated in the literature to IOR. An object reference IOR includes a TCP/IP address which uniquely identifies the other device and further object-specific characteristics via which the CORBA object is uniquely identified on the other device.

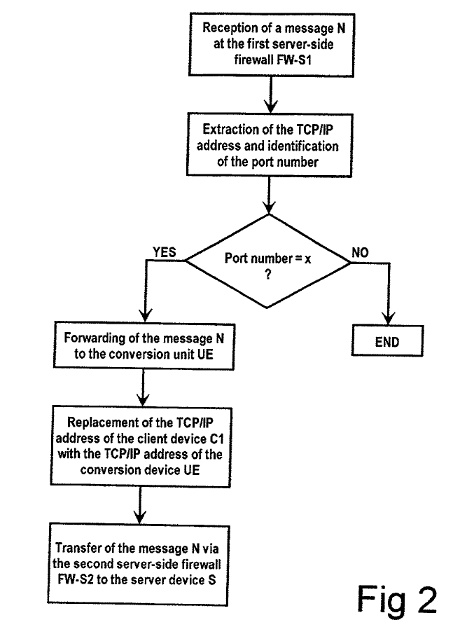

FIG. 2 shows a flow chart illustrating the essential method steps which are performed in a transfer of a message packet N, originating from the first client device C1 to the server device S in the server-side firewall FW-S. The standard procedure being performed in the client-side firewall FW-C is irrelevant to the present invention and, therefore, no further description is provided.

When a message packet N is received at the first firewall FW-S1, the TCP/IP address which is also transmitted is identified from the object reference IOR of the received message packet N. A TCP/IP address generally includes an IP address which identifies the destination device (in the present embodiment the server device S) and a port number, via which an application which initializes and controls the data transmission is uniquely identified on the destination device. In a following step, the port number which is characteristic of the data transmission between the CORBA objects (not shown) is identified from the identified TCP/IP address in which the port number is contained.

If the identified port number corresponds to a pre-configured port number x, the CORBA object running on the first client device C1 is released for data transmission via the server-side firewall FW-S. The length of the port number is 2 bytes. In the configuration of the 2-byte port number for communication between CORBA objects, a port number greater than 1024 is allocated according to the present invention, since the port numbers up to 1024 are already pre-assigned by default. The port numbers from 1024 can be used in a user-individual manner. If the identified port number does not correspond to the pre-configured port number x, the CORBA object running on the first client device C1 is not released for data transmission via the server-side firewall FW-S and the data transmission is prevented.

In cases where the identified port number matches the pre-configured port number x, the first firewall FW-S1 forwards the message packet N to the conversion unit UE. The conversion unit UE temporarily stores the received message packet N, extracts the object reference IOR and replaces the TCP/IP address of the first client device C1 in the object reference IOR with the TCP/IP address of the conversion device.

In a concluding step, the conversion unit UE transfers the message packet via the second firewall FW-S2 to the server device S, whereby the TCP/IP address is released in the second firewall FW-S2 for data transmission via the second firewall FW-S2.

For data transmission, originating from a device C3, S connected to the server network LAN-S, to a device C1, C2 connected to the client network LAN-C or to the fourth client device C4, the method described above is performed analogously in the opposite direction.

Data transmission between the CORBA objects is performed via the IIOP protocol (Internet Inter-ORB Protocol) which is known per se and is based on the TCP/IP protocol.

For the method according to the present invention, only a port number x which is released for communication between distributed CORBA objects needs to be defined both in the devices C, S connected to the networks LAN-C, LAN-S, IP-N and in the firewall devices FW.

Although the present invention has been described with reference to specific embodiments, those of skill in the art will recognize that changes may be made thereto without departing from the spirit and scope of the present invention without departing from the hereafter appended claims.

1. A method for data transmission between a first device and a second device via an IP-oriented network, the method comprising the steps of:
providing a security device disposed between the first and the second devices;
transmitting a message by the first device; and
ascertaining, when the message transmitted by the first device is received at the security device, with reference to a subcomponent of the received message, whether the first device is released for data transmission via the security device.

2. A method for data transmission between a first device and a second device via an IP-oriented network as claimed in claim 1, wherein the data transmission is initialized and controlled by CORBA applications running on the first and second devices.

3. A method for data transmission between a first device and a second device via an IP-oriented network as claimed in claim 1, wherein the message is transmitted via a TCP/IP connection.

4. A method for data transmission between a first device and a second device via an IP-oriented network as claimed in claim 1, wherein the message is transmitted between the first device and the second device based on an IIOP protocol.

5. A method for data transmission between a first device and a second device via an IP-oriented network as claimed in claim 2, wherein the subcomponent is formed by a port number of a TCP/IP address which identifies the CORBA applications.

6. A method for data transmission between a first device and a second device via an IP-oriented network as claimed in claim 5, wherein the port number is greater than 1024.

7. A method for data transmission between a first device and a second device via an IP-oriented network as claimed in claim 1, wherein the security device includes a first security unit, a second security unit and a conversion unit disposed between the first and second security units, and a check is carried out on the subcomponent by the first security device.

8. A method for data transmission between a first device and a second device via an IP-oriented network as claimed in claim 7, wherein, in cases where the message is released for transmission via the security device, the message is forwarded to the conversion device.

9. A method for data transmission between a first device and a second device via an IP-oriented network as claimed in claim 8, wherein, via the conversion unit, a TCP/IP address which identifies the first device is replaced in the message with a TCP/IP address which identifies the conversion unit, and the message is forwarded via the second security unit to the second device.
